(19) United States
(12) Patent Application Publication
(10) Pub. No.: US 2004/0194912 A1
(43) Pub. Date: Oct. 7, 2004

(54) Air-cooled-type heat exchanging apparatus

(76) Inventor: Keita Honda, Okazaki-city (JP)

Correspondence Address: HARNESS, DICKEY & PIERCE, P.L.C., P.O. BOX 828, BLOOMFIELD HILLS, MI, 48303, US

(21) Appl. No.: 10/736,877

(22) Filed: Dec. 16, 2003

(30) Foreign Application Priority Data
Dec. 26, 2002 (JP) 2002-376414

(51) Int. Cl. B60H 3/00; B61D 27/00

(52) U.S. Cl. 165/42

(57) ABSTRACT

When the first heat exchanger (the condenser) 4 is arranged on the upstream side of the first radiator 5 in the cooling wind flowing direction, a cooling wind not receiving heat from refrigerant flows into the second radiator 6. Due to the foregoing, even when the first radiator 5 and the second radiator 6 are integrated into one body so as to reduce a space in which the components are arranged, it is possible for the second radiator 6 to air-cool the second cooling water to a temperature not higher than 65° C.

### BACKGROUND OF THE INVENTION

1. Field of the Invention

The present invention relates to an arrangement and structure of: a first heat exchanger (a condenser) for air-cooling refrigerant circulating in a refrigerating cycle of a hybrid type automobile provided with a running engine and running motor; a radiator (a first radiator) for air-cooling cooling water (a first cooling water) to cool the running engine; and a radiator (a second radiator) for air-cooling cooling water (a second cooling water) to cool electric parts relating to the running motor.

2. Description of the Related Art

Conventionally, concerning the air-cooled-type heat exchanging apparatus provided in a hybrid type automobile in which the refrigerant circulating in the first heat exchanger (the condenser), the first cooling water circulating in the first radiator and the second cooling water circulating in the second radiator are simultaneously air-cooled, the first heat exchanger, the first radiator and the second radiator are arranged in series in the air flowing direction so as to simplify the structure of the apparatus. For example, this air-cooled-type heat exchanging apparatus is disclosed in the official gazette of JP-A-2002-187435. Further, in the air-cooled-type heat exchanging apparatus in which the first heat exchanger, the first radiator and the second radiator are arranged in series in the air flowing direction, a rotating speed of the air cooling fan is controlled according to the temperature of the electric parts relating to the running motor. For example, this air cooled type heat exchanging apparatus is disclosed in the official gazette of JP-A-2002-223505.

Recently, there is a demand for reducing a space in which components are arranged. Therefore, as disclosed in the official gazettes of JP-A-2002-187435 and JP-A-2002-223505, the following air cooled heat exchanging apparatus has been investigated. Three components of the first radiator, the second radiator and the first heat exchanger are not arranged in series in the air flowing direction but the first and the second radiator are integrated into an integrated type radiator, and the two components of the first heat exchanger and the integrated type radiator are arranged in series in the air flowing direction.

In this case, temperature of the first cooling water to cool the running engine is allowed to be 110° C. Therefore, the first cooling water to cool the running engine can be sufficiently air-cooled by air to which heat has been radiated from the refrigerant in the outdoor heat exchanger. However, temperature of the second cooling water to cool the electric parts relating to the running motor must be kept at a value not higher than 65° C. so that the electric parts can be protected from heat. Accordingly, there is a possibility that the second cooling water can not be air-cooled to a temperature not higher than 65° C. by air to which heat has been moved from the refrigerant in the first heat exchanger.

### SUMMARY OF THE INVENTION

It is an object of the present invention to provide an air-cooled-type heat exchanging apparatus, which is used for a hybrid type automobile, having a first heat exchanger (a condenser), a first radiator and a second radiator, characterized in that: even when the first and the second radiator are integrated into one body so as to reduce a space in which the components are arranged, the second cooling water can be air-cooled to a temperature not higher than 65° C. by the second radiator.

According to an aspect of the present invention, in an air-cooled-type heat exchanger used for a hybrid type automobile including a first heat exchanger for air-cooling refrigerant and also including an integrated type radiator having a first radiator, which is arranged in series to the first heat exchanger on the downstream side in the air flowing direction, for air-cooling a first cooling water and also having a second radiator, which is arranged in parallel with the first radiator on one side of the first radiator in the vertical direction, for air-cooling a second cooling water, when the temperature of air flowing into the second radiator is made to be lower than the temperature of air flowing into the first radiator, the temperature of air for air-cooling the second cooling water becomes lower than the temperature of air for air-cooling the first cooling water. Therefore, even when the first and the second radiator are integrated into one body so as to reduce a space in which the components are arranged, the second cooling water can be air-cooled to a temperature not higher than 65° C. by the second radiator.

According to another aspect of the present invention, in an air-cooled-type heat exchanger used for a hybrid type automobile including a first heat exchanger for air-cooling refrigerant and also including an integrated type radiator having a first radiator, which is arranged in series to the first heat exchanger on the downstream side in the air flowing direction, for air-cooling a first cooling water and also having a second radiator, which is arranged in parallel with the first radiator on one side of the first radiator in the vertical direction, for air-cooling a second cooling water, when a flow rate of the air flowing into the second radiator is made higher than that of the air flowing into the first radiator, the flow rate of the air to air-cool the second cooling water becomes more than that of the air to air-cool the first cooling water. Therefore, the same effect as that of the embodiment described before can be provided.

In still another aspect of the present invention, the first heat exchanger is arranged in such a manner that the first heat exchanger is only opposed to the upstream side of the first radiator in the air flowing direction.

Due to the foregoing, the air to which heat is not radiated from the refrigerant in the first heat exchanger can be made to flow into the second radiator. Therefore, the temperature of the air to air-cool the second cooling water becomes lower than the temperature of the air to air-cool the first cooling water. Further, no obstacles are arranged on the upstream side of the second radiator and air resistance is low. Therefore, the flow rate of the air for air-cooling the second cooling water becomes more than that of the air for air-cooling the first cooling water. Accordingly, the same effect as that described before can be provided.

According to still another aspect of the present invention, in the first heat exchanger, refrigerant flows only in a portion opposed to the upstream side of the first radiator in the air flowing direction.

Therefore, the air flowing into the second radiator is not affected by the heat radiated from the refrigerant flowing in the first heat exchanger. Accordingly, the temperature of air for air-cooling the second cooling water becomes lower than the temperature of air for air-cooling the first cooling water. Due to the foregoing, the same effect as that described before can be provided.

According to still another aspect of the present invention, air resistance in a portion of the first heat exchanger opposing to the upstream side of the first radiator in the air flowing direction is made to be higher than air resistance in a portion of the first heat exchanger opposing to the upstream side of the second radiator in the air flowing direction.

Due to the foregoing, the flow rate of the air flowing into the second radiator becomes more than that of the air flowing into the first radiator. Accordingly, the flow rate of the air for air-cooling the second cooling water becomes more than that of the air for air-cooling the first cooling water. Due to the foregoing, the same effect as that described before can be provided.

According to still another aspect of the present invention, the delivery side of refrigerant of the first heat exchanger is arranged being opposed to the upstream side of the second radiator in the air flowing direction.

Due to the foregoing, the air flowing into the second radiator is given a smaller quantity of heat from the refrigerant in the first heat exchanger. Therefore, the temperature of the air for air-cooling the second cooling water becomes lower than the temperature of the air for air-cooling the first cooling water. Due to the foregoing, the same effect as that described before can be provided.

According to still another aspect of the present invention, the supercooling section to supercool the refrigerant in the first heat exchanger is arranged being opposed to the upstream side of the second radiator in the air flowing direction.

Due to the foregoing, the air flowing into the second radiator is given a smaller quantity of heat from the refrigerant in the first heat exchanger. Therefore, the temperature of the air for air-cooling the second cooling water becomes lower than the temperature of the air for air-cooling the first cooling water. Due to the foregoing, the same effect as that described before can be provided.

The present invention may be more fully understood from the description of preferred embodiments of the invention, as set forth below, together with the accompanying drawings.

### BRIEF DESCRIPTION OF THE DRAWINGS

In the drawings:

FIG. 1 is an arrangement view showing an overall arrangement of the air-cooled-type heat exchanging apparatus, the refrigerating cycle, the first cooling water circuit and the second cooling water circuit of the first embodiment of the present invention;

FIG. 2 is an arrangement view showing an air-cooled-type heat exchanging apparatus of the second embodiment of the present invention;

FIG. 3 is a graph showing a transition of the refrigerant temperature in the refrigerant flowing direction in the first heat exchanger of the air-cooled-type heat exchanging apparatus of the second embodiment.

FIGS. 4A and 4B are schematic illustrations respectively showing flows of the refrigerant in the first heat exchangers of the air-cooled-type heat exchanging apparatus of the second and the third embodiments;

FIG. 5 is an arrangement view showing an air-cooled-type heat exchanging apparatus of the third embodiment of the present invention; and

FIG. 6 is an arrangement view showing an air-cooled-type heat exchanging apparatus of the fourth embodiment of the present invention.

### DESCRIPTION OF THE PREFERRED EMBODIMENTS

(First Embodiment)

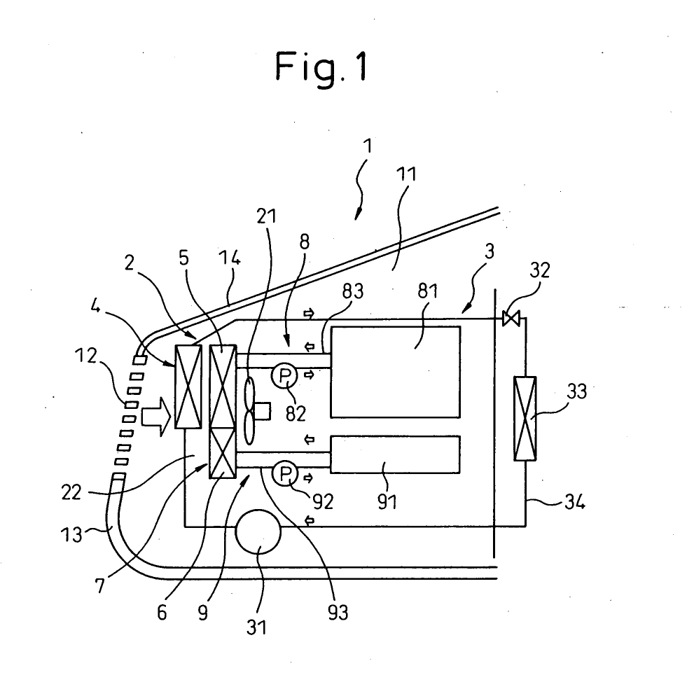

Referring to FIG. 1, the constitution of the first embodiment of the present invention will be explained below. The air-cooled-type heat exchanging apparatus 2 of the first embodiment is arranged in the front portion of the engine compartment 11 of the hybrid type automobile 1 having the running engine 81 and the running motor not shown in the drawing. In the front of the air cooled type heat exchanging apparatus 2, the front grille 12 to guide an air flow into the engine compartment 11 is arranged at a position on the upper side of the front bumper 13 on the lower side at the front end of the hood 14.

The air-cooled-type heat exchanging apparatus 2 includes: a first heat exchanger (a condenser) 4 for cooling the refrigerant circulating in the refrigerating cycle 3; an integrated type radiator 7 having a first radiator 5 for air-cooling the first cooling water to cool the running engine 81, arranged in series to the first heat exchanger 4 on the downstream side of the first heat exchanger 4 in the air flowing direction and also having a second radiator 6 for air-cooling the second cooling water to cool the electric parts 91 related to the running motor (which will be referred to as related electric parts, hereinafter), arranged in parallel with the first radiator 5 on the lower side of the first radiator 5 in the vertical direction; and an air cooling fan 21 for guiding air through the front grille 12, arranged in series to the integrated radiator 7 on the downstream side in the air flowing direction.

The related electric parts 91 are: a running motor inverter (not shown) which converts DC electric power of the main battery, which is mounted on an automobile, into predetermined AC electric power in three phases and also converts this AC electric power in three phases according to a command given from the engine control unit (ECU) (not shown) and outputs the converted electric power into the running motor so as to control the rotating speed of the running motor; a DC-DC converter (not shown) which converts DC electric power of the main battery, which is mounted on the automobile, into predetermined DC electric power and outputs the thus converted DC electric power into the auxiliary machine battery (not shown) for driving the auxiliary machines, which are mounted on the hybrid type automobile 1, so as to electrically charge this auxiliary machine battery; and an air-conditioner inverter (not shown) which converts DC electric power of the auxiliary machine battery into predetermined AC electric power in three phases and further converts this AC electric power in three phases according to a command of the ECU and outputs the converted electric power into the drive motor not shown for driving the refrigerant compressor 31 so as to control the rotating speed of the refrigerant compressor 31.

The first heat exchanger 4 is arranged only on the upstream side of the first radiator 5 in the air flowing direction. A space formed on the lower side of the first heat exchanger 4, that is, an upstream side of the second radiator 6 in the air flowing direction is formed into a bypass passage 22 for directly guiding the air, which has been introduced through the front grille 12, into the second radiator 6.

The refrigerating cycle 3 having the first heat exchanger (the condenser) 4 includes: a refrigerant compressor 31 for compressing refrigerant gas into refrigerant gas of high temperature and pressure; a refrigerant expansion valve 32 for expanding refrigerant liquid which has been liquidized when it is air-cooled by the first heat exchanger 4; and a second heat exchanger (a refrigerant evaporator) 33 for cooling and dehumidifying air, which has been introduced into the passenger's compartment of the hybrid type automobile 1, by depriving the air of the heat of vaporization of the refrigerant liquid. These components are connected with each other by the refrigerant pipe 34 so that the refrigerant can flow in the order of the refrigerant compressor 31, first heat exchanger 4, refrigerant expansion valve 32 and second heat exchanger (refrigerant evaporator) 33.

The first radiator 5 composes a first cooling water circuit 8 together with the running engine 81 and the first cooling water pump 82 for circulating the first cooling water. These components are connected with each other by the first cooling water pipe 83 so that the first cooling water can flow in the order of the first cooling water pump 82, the running engine 81 and the first radiator 5.

The second radiator 6 composes the second cooling water circuit 9 together with the related electric parts 91 and the second cooling water pump 92 for circulating the second cooling water. These components are connected with each other by the second cooling water pipe 93 so that the cooling water can flow in the order of the second cooling water pump 92, the related electric parts 91 and the second radiator 6.

In the refrigerating cycle 3, refrigerant gas of high temperature and pressure discharged from the refrigerant compressor 31 is cooled and liquefied in the first heat exchanger 4 into liquid refrigerant by the air (referred to as a cooling air wind, hereinafter) introduced by the air cooling fan 21 through the front grille 12. Liquid refrigerant is expanded and atomized by the refrigerant expansion valve 32. The thus expanded refrigerant cools and dehumidifies the air to be introduced into the passenger's compartment and vaporized. The thus vaporized refrigerant is compressed again to a high temperature at high pressure by the refrigerant compressor 31. In this way, the refrigerating cycle is repeated.

In the first cooling water circuit 8, the first cooling water discharged from the first cooling water pump 82 is sent to the running engine 81 and cools it. After that, the first cooling water is sent to the first radiator 5 and cooled by a cooling wind, which has passed through the first heat exchanger 4, and discharged again by the first cooling water pump 82.

In the second cooling water circuit 9, the second cooling water discharged from the second cooling water pump 92 is sent to the related electric parts 91 and cools them. After that, the second cooling water is sent to the second radiator 6, cooled by a cooling wind, which has passed through the bypass circuit 22, and discharged again from the second cooling water pump 92.

In this case, a portion of the cooling wind receives heat radiated from the refrigerant gas of high temperature and pressure flowing in the first heat exchanger 4, and the temperature of the portion of the cooling wind is raised. After that, the portion of the cooling wind is guided to the first radiator 5 so as to air-cool the first cooing water. Thus, this portion of the cooling wind can be sufficiently used for air-cooling, the upper limit temperature of which is 110° C. Therefore, an increase in the temperature of the running engine 81 can be prevented, and the running engine 81 can be properly operated.

On the other hand, the residual portion of the cooling wind passes through the bypass passage 22 and flows into the second radiator 6 and air-cools the second cooling water without receiving heat radiated from the refrigerant gas of high temperature and pressure in the first heat exchanger 4. Accordingly, this residual portion of the cooling wind can be sufficiently used for air-cooling, the upper limit temperature of which is 65° C. Therefore, an increase in the temperature of the related electric parts 91 can be prevented, and the performance of the related electric parts 91 can be surely maintained.

In an air-cooled heat exchanger 2 used for a hybrid type automobile 1 including a first heat exchanger 4 for air-cooling refrigerant circulating in the refrigerating cycle 3 and also including an integrated type radiator 7 having a first radiator 5, which is arranged in series to the first heat exchanger 4 on the downstream side in the air flowing direction of cooling air, for air-cooling a first cooling water and also having a second radiator 6 which is arranged in parallel with the first radiator 5 on one side of the first radiator 5 in the vertical direction, for air-cooling a second cooling water to cool related electric parts 91, when the first heat exchanger 4 is arranged only on the upstream side of the first radiator 5 in the flowing direction of the cooling wind, a cooling wind not receiving heat from the refrigerant in the first heat exchanger 4 flows into the second radiator 6. Therefore, the temperature of the cooling wind flowing into the second radiator 6 can be made lower than the temperature of the cooling wind flowing into the first radiator 5. Further, no first heat exchanger 4 is arranged on the upstream side of the second radiator 6 and the air resistance is low. Therefore, the flow rate of the cooling wind flowing into the second radiator 6 becomes more than that of the cooling wind flowing into the first radiator 5. Due to the foregoing, even when the first radiator 5 and the second radiator 6 are integrated into one body so as to reduce the space in which the components are arranged, it is possible for the second radiator 6 to air-cool the second cooling water to a temperature not higher than 65° C.

(Second Embodiment)

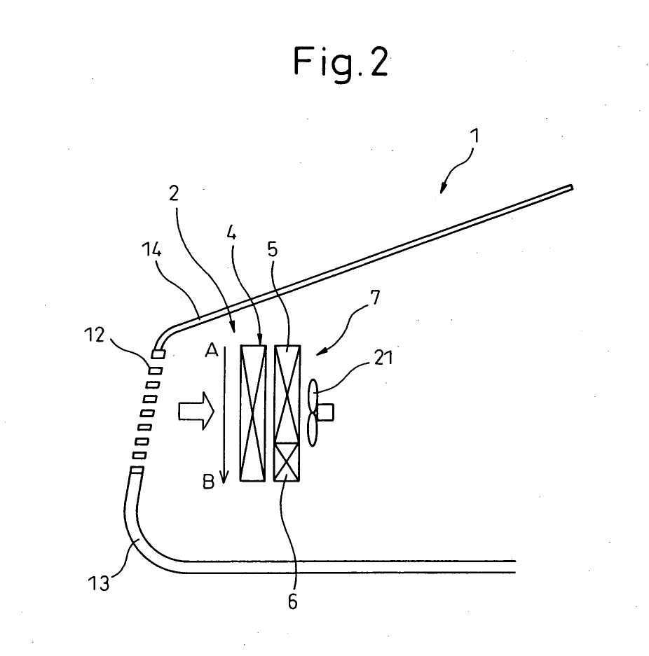

In the second embodiment of the present invention, the first heat exchanger (the condenser) 4 is arranged on the upstream side of the cooling air flowing direction of both the first radiator 5 and the second radiator 6 as shown in FIG. 2.

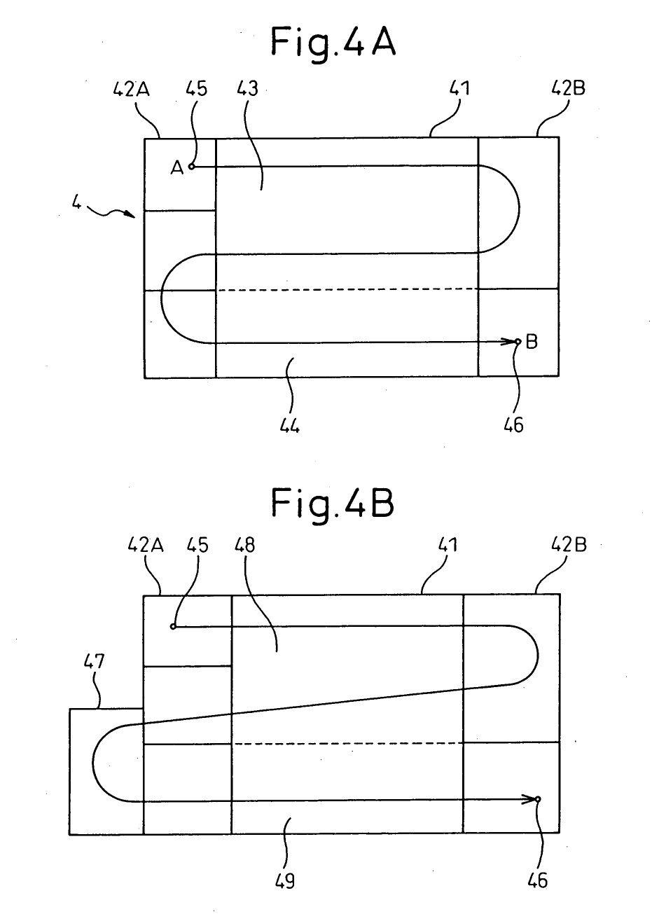

As shown in FIG. 4A, the first heat exchanger 4 includes: a core portion 41 for exchanging heat with a cooling wind; and tank portions 42A, 42B for distributing and collecting refrigerant, arranged at both ends of the core portion 41. The core portion 41 is divided into two portions in the vertical direction of the first heat exchanger 4. The upper portion of the core portion 41 is opposed to the first radiator 5 and composed of a refrigerant gas cooling portion 43 in which sensible heat of the refrigerant gas is removed. The lower portion of the core portion 41 is opposed to the second radiator 6 and composes a refrigerant condensing portion 44 in which latent heat is taken from the refrigerant gas so that the refrigerant gas can be condensed and liquidized. The inlet 45 of the refrigerant gas is arranged in an upper portion of the tank 42A, and the outlet 46 of the refrigerant liquid, which has been generated when the refrigerant gas is condensed and liquidized in the core portion 41, is arranged in a lower portion of the tank 42B.

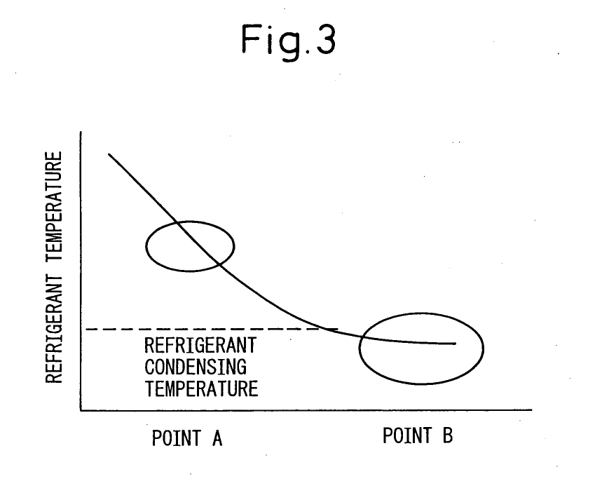

The refrigerant gas, the temperature and pressure of which have been raised by the refrigerant compressor 31, enters the tank 42A from the inlet 45 and is distributed into tubes (not shown) composing the refrigerant gas cooling portion 43 and cooled by the cooling wind. The refrigerant gas is once collected to an upper portion of the tank 42B and then distributed into the tubes composing the refrigerant gas cooling portion 43 and cooled by the cooling wind. In the meantime, as shown by points A and B in FIGS. 3 and 4A, the refrigerant gas is cooled to the condensation temperature of the refrigerant, and a part of the refrigerant is condensed and liquidized and changed into refrigerant liquid. The thus liquidized refrigerant is collected into the intermediate portion of the tank 42A. After that, the two phase refrigerant containing the gas phase and the liquid phase refrigerant is guided into a lower portion of the tank 42A and distributed to the tubes (not shown) composing the refrigerant condensing portion 44 and cooled by the cooling wind, so that the two phase refrigerant can be substantially completely made into refrigerant liquid. Then, the refrigerant liquid is collected to a lower portion of the tank 42B and guided from the outlet 46 to the refrigerant expansion valve 32.

The cooling wind, which has passed through the refrigerant gas cooling portion 43, is guided to the first radiator 5 and cools the first cooling water. On the other hand, the cooling wind, which has passed through the refrigerant condensing portion 44, is guided to the second radiator 6 and cools the second cooling water.

As described above, in the first heat exchanger 4, the cooling wind receives heat from the refrigerant gas, the temperature of which is high, in the refrigerant gas cooling portion 43, and the cooling wind receives heat from the refrigerant, which has been cooled to the refrigerant condensing temperature, in the refrigerant condensing portion 44. Therefore, the temperature of the cooling wind, which has passed through the refrigerant condensing portion 44, is lower than the temperature of the cooling wind which has passed through the refrigerant gas cooling portion 43. Accordingly, the temperature of the cooling wind flowing into the second radiator 6 is lower than the temperature of the cooling wind flowing into the first radiator 5. Due to the foregoing, even when the first radiator 5 and the second radiator 6 are integrated into one body so as to reduce the space in which the components are arranged, it is possible for the second radiator 6 to air-cool the second cooling water to a temperature not higher than 65° C.

(Third Embodiment)

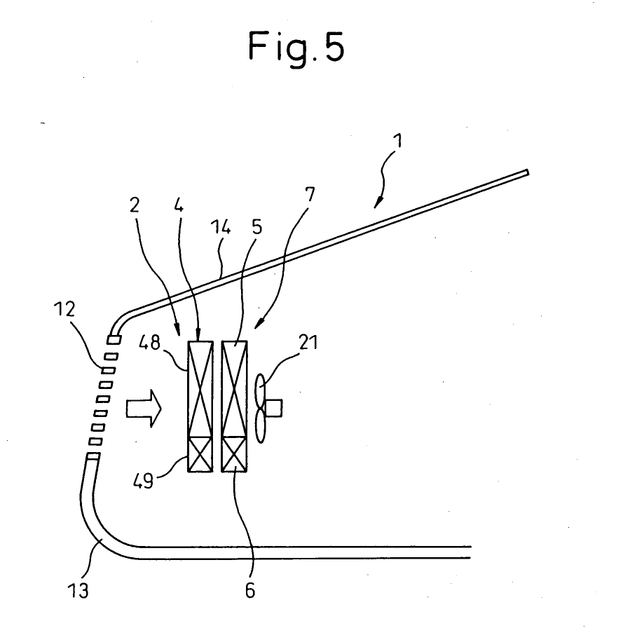

In the third embodiment of the present invention, as shown in FIG. 5, the first heat exchanger (the condenser) 4 is arranged on the upstream side in the cooling wind flowing direction of both the first radiator 5 and the second radiator 6.

As shown in FIG. 4B, the first heat exchanger 4 includes: a core portion 41 for exchanging heat with the cooling wind; tank portions 42A, 42B for distributing and collecting the refrigerant, arranged at both end portions of the core portion 41; and a receiver 47 for temporarily storing the refrigerant liquid. The core portion 41 is divided into two portions in the vertical direction of the first heat exchanger 4. The upper portion of the core portion 41 is opposed to the first radiator 5 and composes a refrigerant condensing portion 48 in which sensible heat is taken from the refrigerant gas so that the refrigerant gas can be condensed and liquefied. The lower portion of the core portion 41 is opposed to the second radiator 6 and composes a supercooling portion 49 mainly used for further cooling the refrigerant liquid.

The refrigerant gas, the high temperature and high pressure of which have been raised by the refrigerant compressor 31, is sent to an upper portion of the tank 42A from the inlet 45 and distributed to tubes (not shown) composing the refrigerant gas condensing portion 48 and cooled by a cooling wind. After the refrigerant gas has been once collected to an upper portion of the tank 42B, it is distributed again to the tubes composing the refrigerant gas condensing portion 48 and cooled by the cooling wind. In the meantime, substantially all the refrigerant gas is liquefied and condensed so that it becomes refrigerant liquid. Thus obtained refrigerant liquid is collected to an intermediate portion of the tank 42A. After that, the refrigerant liquid is guided to the receiver 47, and a necessary quantity of the refrigerant liquid is supplied to a lower portion of the tank 42A and distributed to tubes (not shown) composing the supercooling portion 49 and supercooled by the cooling wind. Then the refrigerant liquid is collected to a lower portion of the tank 2B and guided to the refrigerant expansion valve 32 from the outlet 46.

As described above, in the outdoor heat exchanger 4, the refrigerant gas, the temperature of which is higher than the refrigerant condensing temperature, and the refrigerant liquid, the temperature of which is substantially equal to the refrigerant condensing temperature flow in the refrigerant gas condensing portion 48, and the refrigerant liquid, which is supercooled to a temperature not higher than the refrigerant condensing temperature, flows in the supercooling portion 49. Accordingly, the temperature of the cooling wind passing through the supercooling portion 49 is lower than the temperature of the cooling wind passing through the refrigerant gas condensing portion 48. Therefore, the temperature of the cooling wind flowing into the second radiator 6 is lower than the temperature of the cooling wind flowing into the first radiator 5. Due to the foregoing, even when the first radiator 5 and the second radiator 6 are integrated into one body so as to reduce the space in which the components are arranged, it is possible to air-cool the second cooling water to a temperature not higher than 65° C. by the second radiator 6.

(Fourth Embodiment)

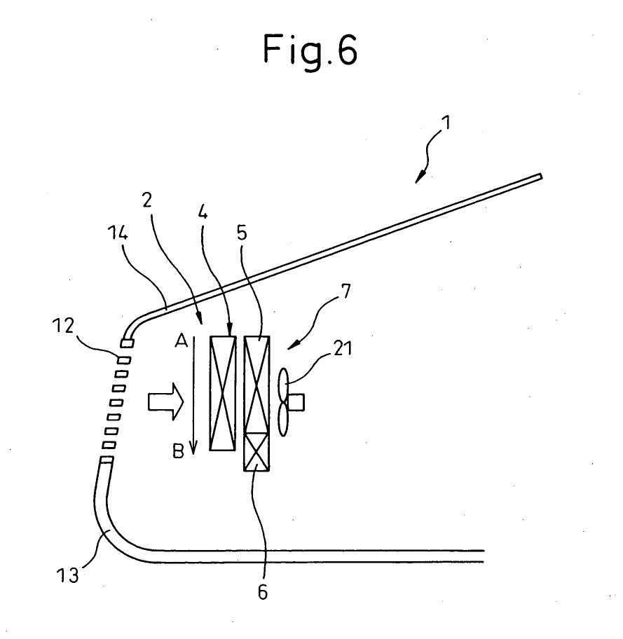

In the second embodiment, the first heat exchanger (the condenser) 4 is arranged on the upstream side of both the first radiator 5 and the second radiator 6 in the cooling air flowing direction. That is, in the second embodiment, the lower end portion of the outdoor heat exchanger 4 extends to a position of the lower end portion of the second radiator 6. However, in the fourth embodiment of the present invention, as shown in FIG. 6, the lower end portion of the first heat exchanger 4 extends to a position close to the intermediate position of the second radiator 6 in the vertical direction.

The operational effect of this fourth embodiment is substantially the same as that of the second embodiment explained before. The cooling air passing through the refrigerant condensing portion 44, which is a lower portion of the core portion 41 of the first heat exchanger 4, is guided to the second radiator 6 and air-cools the second cooling water. On the other hand, the cooling air passing through the refrigerant gas cooling portion 43, which is an upper portion of the core portion 41 of the first heat exchanger 4, is guided to the first radiator 5 and air-cools the first cooling water. The cooling wind receives heat from the refrigerant gas of high temperatures in the refrigerant cooling portion 43. The cooling wind receives heat from the refrigerant gas, which has been cooled to the refrigerant condensing temperature, in the refrigerant condensing portion 44. Accordingly, the temperature of the cooling wind, which has passed through the refrigerant condensing portion 44, is lower than the temperature of the cooling wind which has passed through the refrigerant gas cooling portion 43. Therefore, the temperature of the cooling wind flowing into the second radiator 6 becomes lower than the temperature of the cooling wind flowing into the radiator 5. Accordingly, it is possible to air-cool the second cooling water to a temperature not higher than 65° C. by the second radiator 6.

On the upstream side of the second radiator 6, the outdoor heat exchanger 4 is arranged so that a portion of the outdoor heat exchanger 4 corresponding to the upper half of the second radiator 6 can be opposed to the outdoor heat exchanger 4. Therefore, the air resistance in the case of the fourth embodiment is lower than that in the case of the second embodiment in which the outdoor heat exchanger 4 is arranged so that the outdoor heat exchanger 4 can be opposed to the entire face of the second radiator 6. According to the reduction of the air resistance, a flow rate of the cooling wind flowing into the second radiator can be increased.

(Another Embodiment)

In the first embodiment, the integrated type radiator 7 is composed in such a manner that the second radiator 6 is provided on the lower side of the first radiator 5 in the vertical direction. However, the second radiator 6 may be provided on the upper side of the first radiator 5 in the vertical direction. In this case, a space on the upper side of the first heat exchanger 4 is used as a bypass passage 22, and the cooling wind guided into the second radiator 6 passes through the bypass passage 22 without being given heat from the first heat exchanger 4.

In the case where it is necessary to surround the peripheries of the first heat exchanger 4 and the integrated type radiator 7 with a shroud having a function of a duct so that the dispersion of the cooling wind can be prevented and the cooling wind can be intensively guided to the first heat exchanger 4 and the integrated type radiator 7, the heat exchanger may be composed in such a manner that the refrigerant is made not to flow in a portion opposing to the second radiator 6 (the second radiator opposing portion) in the first heat exchanger 4 so that the temperature of the cooling wind guided into the second radiator 6 can not be raised. Further, in the case where the refrigerant is also made to flow in the second radiator opposing portion, in order to prevent the temperature of the cooling wind, which is guided into the second radiator 6, from being raised, the coefficient of heat transfer of the second radiator opposing portion may be made to be lower than that of the portion opposed to the first radiator 5. Specifically, the pitch of fins (not shown) of the second radiator opposing portion or the pitch of tubes (not shown) may be increased to be larger than that of the portion opposed to the first radiator 5.

While the invention has been described by reference to specific embodiments chosen for purposes of illustration, it should be apparent that numerous modifications could be made thereto by those skilled in the art without departing from the basic concept and scope of the invention.

1. An air-cooled-type heat exchanging apparatus comprising:
an outdoor heat exchanger for air-cooling refrigerant circulating in a refrigerating cycle, mounted on a hybrid automobile provided with a running engine and a running motor; and
an integrated type radiator having a first radiator for air-cooling a first cooling water to cool the running engine, arranged in series to the first heat exchanger on the downstream side of the first heat exchanger in the air flowing direction and also having a second radiator for air-cooling a second cooling water to cool electric parts related to the running motor, arranged in parallel with the first radiator on one side of the first radiator in the vertical direction,
wherein temperature of air flowing into the second radiator is made to be lower than temperature of air flowing into the first radiator.

2. An air-cooled-type heat exchanging apparatus according to claim 1, wherein the first heat exchanger is arranged so that it can be opposed to only the upstream side of the first radiator in the air flowing direction.

3. An air-cooled-type heat exchanging apparatus according to claim 1, wherein refrigerant flows only in a portion of the first heat exchanger opposed to the upstream side of the first radiator in the air flowing direction.

4. An air-cooled-type heat exchanging apparatus according to claim 1, wherein air resistance of a portion of the first heat exchanger opposed to the upstream side of the first radiator in the air flowing direction is higher than air resistance of a portion of the first heat exchanger opposed to the upstream side of the second radiator in the air flowing direction.

5. An air-cooled-type heat exchanging apparatus according to claim 1, wherein an outlet side of refrigerant of the first heat exchanger is arranged being opposed to the upstream side of the second radiator in the air flowing direction.

6. An air-cooled-type heat exchanging apparatus according to claim 1, wherein the first heat exchanger is a refrigerant condenser for condensing and liquefying refrigerant by exchanging heat with air, and a supercooling portion of the refrigerant condenser for supercooling refrigerant liquid is arranged being opposed to the upstream side of the second radiator in the air flowing direction.

7. An air-cooled-type heat exchanging apparatus comprising:
a first heat exchanger for air-cooling refrigerant circulating in a refrigerating cycle, mounted on a hybrid automobile provided with a running engine and a running motor; and
an integrated type radiator having a first radiator for air-cooling a first cooling water to cool the running engine, arranged in series to the first heat exchanger on the downstream side of the first heat exchanger in the air flowing direction and also having a second radiator for air-cooling a second cooling water to cool electric parts related to the running motor, arranged in parallel with the first radiator on one side of the first radiator in the vertical direction,
wherein a flow rate of air flowing into the second radiator is made to be higher than a flow rate of air flowing into the first radiator.

8. An air-cooled-type heat exchanging apparatus according to claim 7, wherein the first heat exchanger is arranged being opposed only to the upstream side of the first radiator in the air flowing direction.

9. An air-cooled-type heat exchanging apparatus according to claim 7, wherein refrigerant is made to flow only in a portion of the first heat exchanger opposed to the upstream side of the first radiator in the air flowing direction.
